(19) United States
(12) Patent Application Publication
(10) Pub. No.: US 2019/0283271 A1
(43) Pub. Date: Sep. 19, 2019

(54) MANUFACTURING METHOD OF TURBINE BLADE MEMBER

(71) Applicant: MITSUBISHI HEAVY INDUSTRIES, LTD., Tokyo (JP)

(72) Inventors: Yasuhiko TSURU, Tokyo (JP); Mineaki MATSUMOTO, Tokyo (JP); Amirthan GANESAN, Tokyo (JP); Takayuki KURIMURA, Tokyo (JP)

(21) Appl. No.: 16/222,229

(22) Filed: Dec. 17, 2018

(30) Foreign Application Priority Data
Mar. 14, 2018 (JP) 2018-047002

(51) Int. Cl. B28B 1/40; F01D 5/28; B28B 3/08

(52) U.S. Cl. CPC B28B 1/40; F01D 5/282; B28B 3/083; F01D 5/286; F01D 5/284

(57) ABSTRACT

A method includes a slurry preparing process of preparing a ceramic powder slurry, an impregnating process of impregnating the slurry into an inorganic fiber sheet to form an impregnated sheet, a sheet winding process of winding an impregnated sheet around a core to form a sheet-wound core, a pressing process of disposing the impregnated sheet between a first mold and a second mold opposed to each other and interposing a spacer therebetween at a portion where the impregnated sheet is not positioned, and then clamping the first mold and the second mold with a first fastener to come close in a direction facing each other, thereby applying pressure to the impregnated sheet, a drying process of heating and drying the impregnated sheet, and a firing process of firing the sheet after drying.

### BACKGROUND

### Technical Field

The present invention relates to a manufacturing method of a turbine blade member made of a ceramic matrix composite.

Priority is claimed on Japanese Patent Application No. 2018-047002 filed Mar. 14, 2018, the content of which is incorporated herein by reference.

### Description of Related Art

Since the past, a ceramic matrix composite in which a ceramic powder slurry such as alumina powder or the like is impregnated into a fiber sheet of a woven fabric or a felt made of ceramic fibers such as alumina fibers, silicon carbide fibers, or the like, and then dried and cured has been known. The ceramic matrix composite of this type is also called oxide CMC, and has excellent properties such as high heat resistance, low thermal conductivity, light weight, and excellent oxidation resistance and corrosion resistance. Recently, use of a ceramic matrix composite for a turbine blade member such as a turbine vane of an industrial gas turbine, or the like has been studied.

As a manufacturing method of a member made of a ceramic matrix composite, a method disclosed in Patent Document 1 is known. That is, a method of impregnating a ceramic fiber woven fabric with a ceramic powder slurry to prepare a prepreg material (a slurry-impregnated sheet), placing the prepreg material in a bag to be inserted into an autoclave, and then pressing and heating it altogether under air pressure during heating and further drying and curing it has been proposed.

On the other hand, a turbine vane of a turbine usually has a hollow portion for cooling formed therein. As a manufacturing method of a member having such a hollow portion with a ceramic matrix composite, a method disclosed in Patent Document 2 has been proposed. In the method disclosed in Patent Document 2, a ceramic fiber cylindrical fabric having a hollow portion is produced by weaving ceramic fibers in a cylindrical shape, and the cylindrical fabric is formed into a shape of a turbine vane member, and then is impregnated with a ceramic using a ceramic slurry or the like, thereby forming a matrix of a ceramic matrix composite.
[Patent Document 1] Japanese Unexamined Patent Application, First Publication No. 2008-24585
[Patent Document 2] Japanese Patent No. 5093165

### SUMMARY OF THE INVENTION

According to the method described in Patent Document 1, since an expensive and large-sized autoclave is required, there is a problem that equipment cost increases. Further, at the time of drying after pressing the slurry-impregnated sheet (the prepreg material) in which the slurry of the ceramic powder is impregnated into a fiber, the sheet expands and its size and shape, especially its thickness, become large, which greatly affects dimensional accuracy and shape accuracy of the product. However, in the proposal of Patent Document 1, sufficient consideration is not given to these problems, and therefore there is concern of decreased dimensional accuracy and shape accuracy of the product.

In the method described in Patent Document 2, since the ceramic fiber is woven in a cylindrical shape, high cost is required for the equipment and productivity is low. In addition, it is often difficult to weave high strength ceramic fibers into a cylindrical shape. Further, even if they are woven into a cylindrical shape, it is difficult to correct a slight error in dimension, and thus there is a concern that a gas turbine blade member having high dimensional accuracy and shape accuracy may be unable to be manufactured.

The present invention has been made in view of the above circumstances, and provides a method capable of manufacturing a turbine blade member in which easy and inexpensive manufacture of a turbine blade member having a hollow portion with excellent dimensional accuracy and shape accuracy is possible without requiring expensive equipment.

In particular, a manufacturing method of a turbine blade member according to a basic aspect (a first aspect) of the present invention includes:

a slurry preparing process of preparing a slurry in which a ceramic powder is dispersed in a dispersion medium;

an impregnating process of impregnating the slurry into a sheet made of inorganic fibers to form a slurry-impregnated sheet;

a sheet winding process of winding the slurry-impregnated sheet around an outer circumferential surface of a core which has a shape of an outer surface corresponding to a shape of an inner surface of a hollow portion of the turbine blade member to form a sheet-wound core;

a pressing process of disposing the sheet-wound core between mold surfaces of a first mold having a mold surface corresponding to a suction side of the turbine blade member and a second mold having a mold surface corresponding to a pressure side of the turbine blade member, and clamping the first mold and the second mold with first fasteners to come close in a direction facing each other, with the first spacer having a predetermined thickness interposed between the first mold and the second mold at a position where the slurry-impregnated sheet is not positioned, thereby applying pressure to the slurry-impregnated sheet;

a drying process of heating and drying the slurry-impregnated sheet after completion of the pressing process; and

a firing process of firing the sheet after drying.

Also, a manufacturing method of a turbine blade member according to a second aspect of the present invention is the manufacturing method of the turbine blade member according to the first aspect, in which:

the entire core may be integrally formed.

Also, a manufacturing method of a turbine blade member according to a third aspect of the present invention is the manufacturing method of the turbine blade member according to the first aspect, in which:

the core may include a plurality of core segment bodies, and in the sheet winding process, the slurry-impregnated sheet may be wound around each of the core segment bodies, and then the plurality of core segment bodies may be combined to form the sheet-wound core.

Also, a manufacturing method of a turbine blade member according to a fourth aspect of the present invention is the manufacturing method of the turbine blade member according to the third aspect, in which:

in the sheet winding process, the slurry-impregnated sheet may be wound around each of the core segment bodies and the plurality of core segment bodies may be combined, and then another slurry-impregnated sheet may be wound again around an outer surface of the combined core segment bodies to form the sheet-wound core.

Also, a manufacturing method of a turbine blade member according to a fifth aspect of the present invention is the manufacturing method of the turbine blade member according to the third or fourth aspect, in which:

when the plurality of core segment bodies are combined in the sheet winding process, the plurality of core segment bodies may be combined with second fasteners.

Also, a manufacturing method of a turbine blade member according to a sixth aspect of the present invention is the manufacturing method of the turbine blade member according to any one of the first to fifth aspects, in which:

in the drying process, in a state in which a second spacer having a thickness different from that of the first spacer is interposed, instead of the first spacer, between the first mold and the second mold at a position where the slurry-impregnated sheet is not positioned, the first mold and the second mold may be clamped with the first fasteners to come close in the direction facing each other, and in this state, the slurry-impregnated sheet may be heated and dried.

Also, a manufacturing method of a turbine blade member according to a seventh aspect of the present invention is the manufacturing method of the turbine blade member according to the sixth aspect, in which:

in the drying process, a spacer whose thickness is larger than a thickness of the first spacer may be used as the second spacer.

Also, a manufacturing method of a turbine blade member according to an eighth aspect of the present invention is the manufacturing method of the turbine blade member according to any one of the first to seventh aspects, in which:

each of the fasteners may be a bolt.

According to the present invention, it is possible to manufacture a turbine blade member made of a ceramic matrix composite having a hollow portion simply and inexpensively by using a simple equipment configuration, and it is also possible to easily obtain a turbine blade member having excellent dimensional accuracy and shape accuracy.

### BRIEF DESCRIPTION OF THE FIGURES

FIG. 1 is a perspective view showing an example of a turbine blade member manufactured by a manufacturing method according to a first embodiment of the present invention.

FIG. 2 is a schematic view showing an example of an overall process in the manufacturing method of the first embodiment of the present invention.

FIG. 3 is a vertical cross-sectional front view showing a mold device used in the first embodiment in an exploded manner.

FIG. 4 is a vertical cross-sectional front view showing a state of the mold device in a pressing process in the first embodiment.

FIG. 5 is a vertical cross-sectional front view showing a state of the mold device in a drying process in the first embodiment.

FIG. 6 is a perspective view showing an example of a turbine blade member manufactured by a manufacturing method according to a second embodiment of the present invention.

FIG. 7 is a schematic view showing an example of an overall process in the manufacturing method of the second embodiment.

FIG. 8A is a front view of a core used in the second embodiment.

FIG. 8B is a plan view of the core shown in FIG. 8A.

FIG. 9A is a front view showing a state in which a slurry-impregnated sheet is wound around each of core segment bodies in the second embodiment.

FIG. 9B is a plan view of FIG. 9A.

FIG. 10A is a front view showing a state in which core segment bodies with slurry-impregnated sheets wound therearound are assembled in the second embodiment.

FIG. 10B is a plan view of FIG. 10A.

FIG. 11A is a front view showing a state in which a slurry-impregnated sheet is further wound around core segment bodies which are assembled with slurry-impregnated sheets wound therearound in the second embodiment.

FIG. 11B is a plan view of FIG. 11A.

FIG. 12 is a vertical cross-sectional front view showing a state of a mold device in a pressing process in the second embodiment.

### DETAILED DESCRIPTION OF THE INVENTION

Hereinafter, embodiments of the present invention will be described with reference to the drawings.

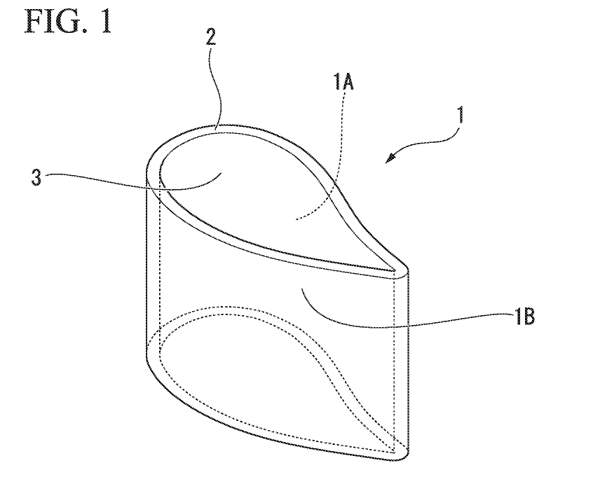

FIG. 1 shows an example of a turbine blade member manufactured according to a first embodiment of the present invention.

Here, as an example of the turbine blade member according to the first embodiment, a main body member (a blade portion) of a turbine vane in a gas turbine is shown. Hereinafter, this turbine blade member will be simply referred to as a turbine vane 1.

In FIG. 1, the turbine vane 1 is made of a ceramic matrix composite (CMC) in which inorganic fibers of oxide-based ceramics such as alumina, mullite or the like or carbide-based ceramics such as silicon carbide or the like are combined and integrated with a ceramic such as alumina, mullite or the like as a matrix. Similarly to general conventional metal vanes, the shape of the turbine vane 1 in FIG. 1 is a hollow tubular shape in which a hollow portion 3 is formed inside an outer shell body 2 having a pressure side 1A forming a concave curved surface and a suction side 1B forming a convex curved surface or a flat surface. The outer shell body 2 is made of the ceramic matrix composite.

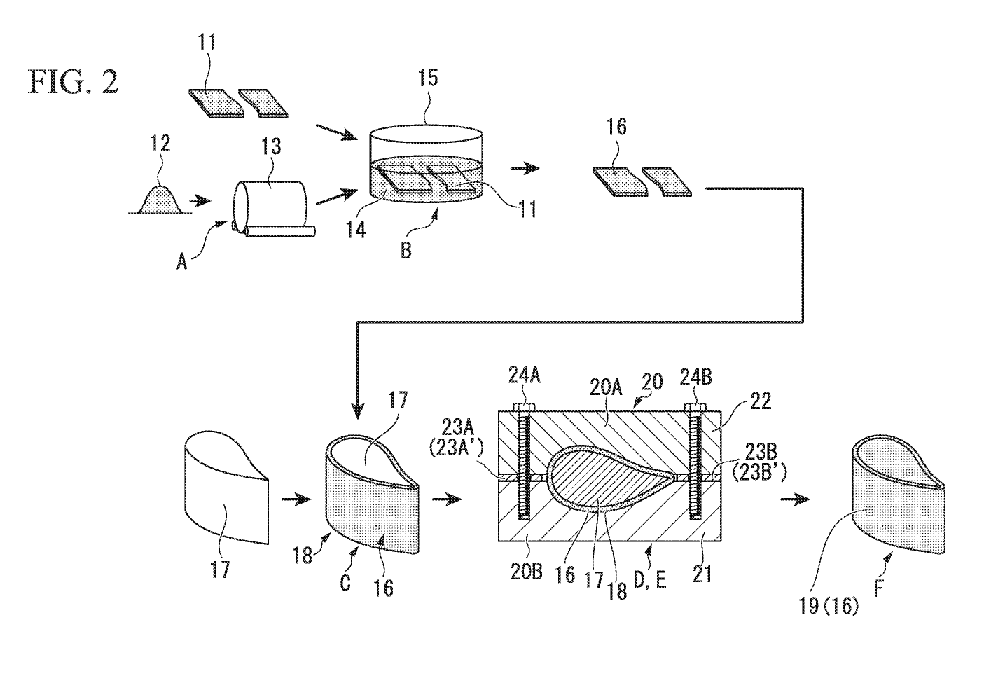

Basically, the manufacturing method of the turbine blade member according to the first embodiment of the present invention has processes A to F shown in FIG. 2.

A: A slurry preparing process of preparing a slurry 14 in which a ceramic powder 12 is dispersed in a dispersion medium. A known general method can be applied to the slurry preparing process A.

B: An impregnating process of impregnating the slurry 14 into a sheet 11 made of inorganic fibers to form a slurry-impregnated sheet 16. A known general method can be applied to the impregnating process B.

C: A sheet winding process of winding the slurry-impregnated sheet 16 around an outer circumferential surface of a core 17, which has a shape of an outer surface corresponding to a shape of an inner surface of the hollow portion 3 of the turbine blade member, for example, of the turbine vane 1 shown in FIG. 1, to form a sheet-wound core 18.

D: A pressing process of pressing the slurry-impregnated sheet 16 of the sheet-wound core 18 with a mold device 20. That is, it is a pressing process in which a mold device 20 formed by combining a first mold 21 having a mold surface corresponding to the suction side 1B of the turbine vane 1 and a second mold 22 having a mold surface corresponding to the pressure side 1A of the turbine vane 1 is used, and the sheet-wound core 18 is disposed between the mold surfaces of the molds 21 and 22 and the mold device 20 is clamped with a fastener, thereby applying pressure to the slurry-impregnated sheet along with the core. In the pressing process, the first mold 21 and the second mold 22 are clamped with first fasteners 24A and 24B such as bolts to come close in a direction facing each other, with first spacers 23A and 23B having a predetermined thickness interposed between the first mold 21 and the second mold 22 at positions where the slurry-impregnated sheet 16 is not located, and pressure is applied to the slurry-impregnated sheet between the molds 21 and 22 and the core 17.

E: A drying process of heating and drying the slurry-impregnated sheet 16 after completion of the pressing process. Also in this drying process, the mold device 20 with spacers interposed therebetween is used in a state in which it is clamped by the fasteners such as bolts to heat and dry the slurry-impregnated sheet in a heating device (not shown) to form a dried sheet 19. Here, in the drying process, the whole mold device 20 may be placed in a drying device (not shown) with the sheet having been pressed in the pressing process retained in the mold device 20 (a state in which the first spacers 23A and 23B used in the drying process are interposed between the molds). However, in order to reduce porosity of a final product and further improve shape accuracy and dimensional accuracy, for the spacers (second spacers) 23A′ and 23B′ in the drying process, it is preferable to make the spacers 23A′ and 23B′ different in thickness from the spacers 23A and 23B used in the pressing process. Specifically, in the drying process, it is preferable to use spacers 23A′ and 23B′ whose thickness is larger than that of the spacers 23A and 23B used in the pressing process.

F: A firing process of firing the slurry-impregnated sheet after drying (the dried sheet 19) to form a turbine vane made of a ceramic matrix composite. A known general method can be applied to the firing process F.

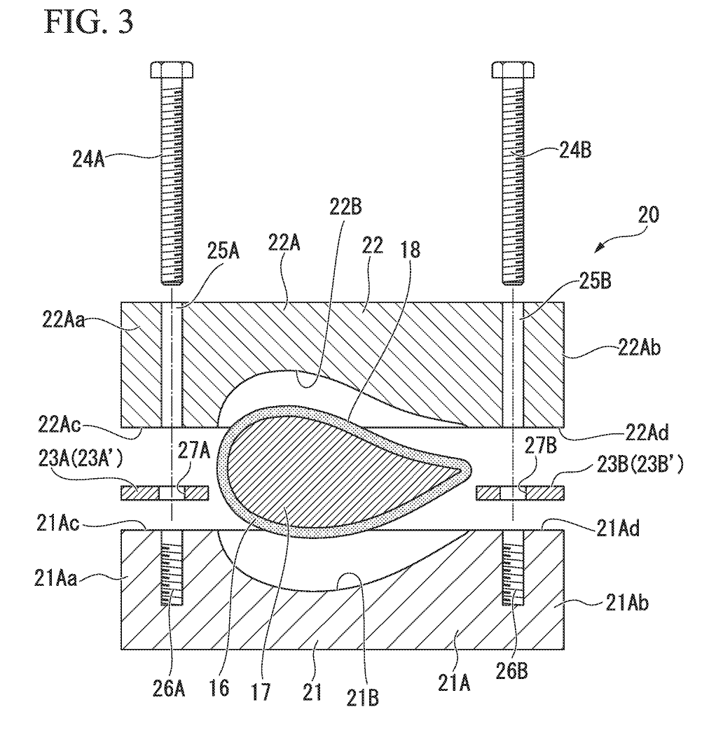

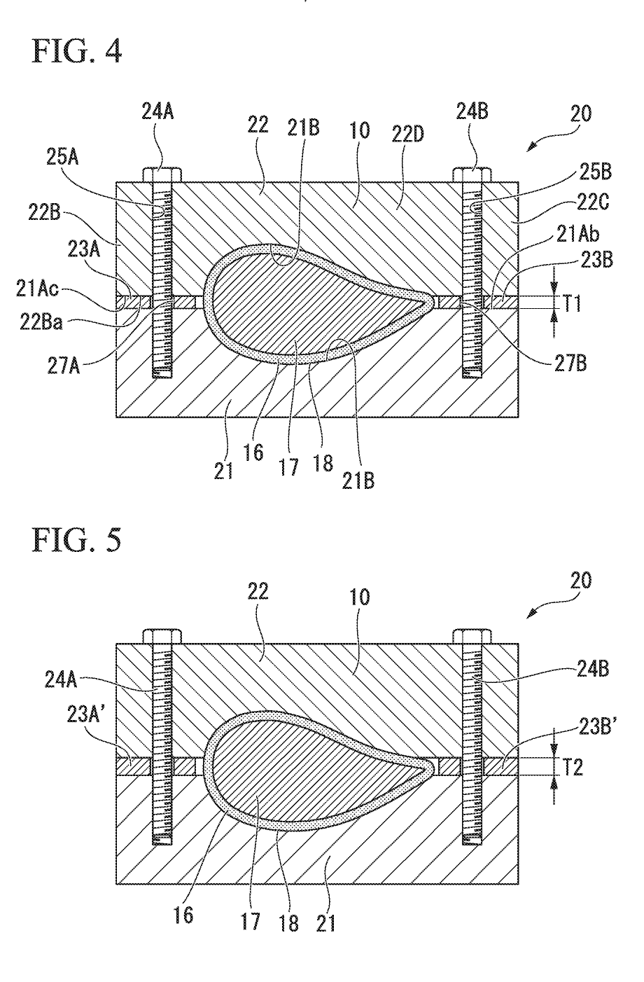

The first embodiment including the processes A to F described above will be described in more detail with reference to FIGS. 3 to 5 in addition to FIG. 2. FIG. 3 shows the mold device used in the first embodiment in an exploded manner, FIG. 4 schematically shows a state of the mold device in the pressing process C, and FIG. 5 schematically shows a state of the mold device in the drying process D.

In the manufacturing method of the present embodiment, as shown in FIG. 2, a sheet 11 made of inorganic fibers and a ceramic powder 12 are prepared in advance. For the sheet 11 made of inorganic fibers, for example, a woven cloth (fabric) obtained by weaving ceramic fibers such as alumina, mullite, or silicon carbide, a nonwoven fabric (felt) obtained by randomly intertwining these ceramic fibers, etc., can be used. For the ceramic powder 12, for example, alumina powder, mullite powder, or the like can be used. The particle size of the ceramic powder 12 is not particularly limited, but one having an average particle size of about 0.1 to 0.2 μm is usually used.

The ceramic powder 12 is fed into a stirring device 13 such as a ball mill or the like and is suspended in water as a dispersion medium to form a slurry 14. This corresponds to the slurry preparing process A described above. In general, water may be used as a dispersion medium for forming a slurry. However, in some cases, a ceramic precursor solution, for example, an alumina precursor solution or the like, may be used as a dispersion medium. Also, in preparing the slurry, it is preferable to add a binder such as polyvinyl alcohol (PVA) or a dispersant to the slurry.

The obtained slurry 14 is poured into, for example, an immersion bath 15, and the aforementioned sheet 11 made of the inorganic fibers is immersed in the slurry 14 in the immersion bath 15 to impregnate voids between the fibers of the sheet 11 with the slurry. The sheet impregnated with the slurry (the slurry-impregnated sheet) 16 may be immediately subjected to the next winding process C, but at this stage, the slurry is not sufficiently infiltrated between the fibers of the sheet 1 in many cases. Therefore, it is usually desirable to further carry out the following steps.

For example, after surfaces of the sheet taken out from the immersion bath 15 are rolled using a rolling roller (not shown), the sheet is temporarily dried, and is then immersed in the slurry of the immersion bath into which the same slurry as described above has been poured. By repeating this process, the slurry-impregnated sheet 16 in which the slurry is uniformly and sufficiently impregnated is obtained.

The slurry-impregnated sheet 16 obtained as described above is wound around an outer circumferential surface of the core 17 (the sheet winding process C). As the core 17, a core whose outward shape corresponds to the shape of an inner surface of the hollow portion 3 of the turbine vane 1, whose size is smaller than an inner diameter size of the hollow portion 3, and which is made of a hard material such as tool steel and the like similarly to molds which will be described later is used. Although the number of turns (the number of layers) for winding the slurry-impregnated sheet 16 may be appropriately determined in accordance with necessity for a thickness of a single layer of the sheet or a thickness of a finally obtained product, it is usually two turns or more. Hereinafter, the core 17 with the slurry-impregnated sheet 16 wound therearound is referred to as a sheet-wound core 18.

The sheet-wound core 18 is subjected to the pressing process D in the mold device 20 and further to the drying process E. In the pressing process D and the drying process E, as will be described later, a mold device 20 having the same configuration except that thicknesses of spacers are different from each other is used.

The mold device 20 used in the first embodiment is shown in FIG. 3 as an exploded view. Also, FIG. 4 shows a state of the mold device 20 in the pressing process D according to the first embodiment, and FIG. 5 shows a state of the mold device 20 in the drying process D according to the first embodiment.

As shown in FIGS. 3 to 5, the mold device 20 according to the present embodiment includes a first mold 21 as a lower mold, a second mold 22 as an upper mold, first spacers 23A and 23B (or second spacers 23A′ and 23B′) arranged at two positions between them, and a plurality of (two in the present embodiment) bolts 24A and 24B as a first fastener for clamping the molds together. The first mold 21, the second mold 22, and the spacers 23A and 23B (23A′ and 23B′) are generally made of a hard steel material such as tool steel or the like, and hard plating such as Cr plating or the like may be appropriately performed on surfaces thereof.

In the first mold 21, a molding recess 21B which has a shape of an inner surface corresponding to a suction side of a turbine vane of a product is formed at a center portion of an upper surface of a horizontal base portion 21A. Upper surfaces (horizontal surfaces) of the portions 21Aa and 21Ab that extend outward more than the molding recess 21B in the base portion 21A of the first mold 21 (side wall portions) are pressure receiving surfaces 21Ac and 21Ad as will be described later.

In the second mold 22, a molding recess 22B which has a shape of an inner surface corresponding to a pressure side of the turbine vane of the product is formed at a center of a lower surface of a horizontal base portion 22A. Lower surfaces (horizontal surfaces) of the portions 22Aa and 22Ab that extend outward more than the molding recess 22B in the base portion 22A of the second mold 22 (side wall portions) are pressing surfaces 22Ac and 22Ad as will be described later.

Also, in the present embodiment, the molding recess 21B having a shape of an inner surface corresponding to a suction side of a turbine vane is formed in the first mold 21 as a lower mold, and the molding recess 22B having a shape of an inner surface corresponding to a pressure side of the turbine vane is formed in the second mold 22 as an upper mold. However, on the other hand, it may also be possible for a molding recess having a shape of an inner surface corresponding to the pressure side of the turbine vane to be formed in the first mold 21 as the lower mold, and a molding recess having a shape of an inner surface corresponding to the suction side of the turbine vane to be formed in the second mold 22 as the upper mold. The same also applies to the second embodiment which will be described later.

In the present embodiment, the pressing surfaces 22Ac and 22Ad on both sides of the lower surface of the base portion 22A of the second mold 22 face the pressure receiving surfaces 21Ac and 21Ad on both sides of the upper surface of the base portion 21A of the first mold 21, respectively. In addition, flat plate-shaped first spacers 23A and 23B (or second spacers 23A′ and 23B′) are interposed between the pressure receiving surfaces 21Ac and 21Ad of the first mold 21 and the pressing surfaces 22Ac and 22Ad of the second mold 22, respectively. Here, for the spacers, as will be described later, those having different thicknesses are used in the pressing process D and the drying process E. Here, in the case of the present embodiment, if the thicknesses of the spacers are T1 and T2 (e.g., T1<T2), the first spacers 23A and 23B having a small thickness T1 are used in the pressing process D, and the second spacers 23A′ and 23B′ having a large thickness T2 are used in the drying process E.

Further, bolt insertion holes 25A and 25B which penetrate in a vertical direction are formed in the side wall portions 22Aa and 22Ab on both sides of the second mold 22, and screw holes 26A and 26B are formed in the vertical direction at positions where the bolt insertion holes 25A and 25B extend downward on the pressure receiving surfaces 21Ac and 21Ad on both sides of the first mold 21. Also, through holes 27A and 27B are formed in the spacers 23A and 23B in the vertical direction to correspond to the bolt insertion holes 25A and 25B and the screw holes 26A and 26B, respectively.

In carrying out the pressing process D with the mold device 20 described above, the aforementioned sheet-wound core 18 is disposed in the molding recess 21B of the first mold 21, and the second mold 22 is lowered to interpose the sheet-wound core 18 between the molding recess 21B of the first mold 21 and the molding recess 22B of the second mold 22. In addition, in a step prior to interposing the sheet-wound core 18 between the first mold 21 and the second mold 22, first spacers 23A and 23B having a small thickness T1 are respectively disposed on the pressure receiving surfaces 21Ac and 21Ad of the first mold 21. Therefore, the first spacers 23A and 23B are interposed between the pressure receiving surfaces 21Ac and 21Ad of the first mold 21 and the pressing surfaces 22Ac and 22Ad of the second mold 22.

In this state, bolts 24A and 24B serving as first fasteners are inserted into the bolt insertion holes 25A and 25B from an upper side of the second mold 22 to penetrate the through holes 27A and 27B of the first spacers 23A and 23B, and are screwed into the screw holes 26A and 26B of the first mold 21 and fastened. That is, in a state where the sheet-wound core 18 is interposed, the second mold 22 is clamped to the first mold 21. The state at that step is shown in FIG. 4.

By tightening the bolts 24A and 24B with the first spacers 23A and 23B having the small thickness T1 interposed between the molds as described above, the slurry-impregnated sheet 16 of the sheet-wound core 18 is pressed and compressed between the core 17 and the upper and lower molds 21A and 21B. In this way, the ceramic powder in the slurry is densely filled between the fibers of the sheet and extra slurry is discharged at the same time.

The process up to this point is the aforementioned pressing process D.

Thereafter, the bolts 24A and 24B are loosened and the mold device 20 is temporarily disassembled to replace the first spacers 23A and 23B with the second spacers 23A′ and 23B′ having a large thickness T2. Then, similarly to the pressing process D described above, the second mold 22 is clamped again to the first mold 21 by fastening the bolts 24A and 24B with the sheet-wound core 18 held therebetween. The state at that step is shown in FIG. 5. Then, while maintaining this state, heating for drying the sheet is performed. This is the aforementioned drying process E.

Here, although the heating means in the drying process E is not particularly limited, for example, the whole mold device 20 may be placed in a drying chamber (not shown) equipped with a heater, or a heater may be embedded in at least one of the first mold 21 and the second mold 22. A heating temperature is usually about 60 to 150 degrees Celsius, and a heating time may be, for example, about 0.5 to 15 hours.

The drying process E is a process for blowing away (evaporating) the water in the slurry, and at the same time, is also a process for finishing the shape and dimensions close to those of a final product. In this drying process E, moisture in the slurry inside the slurry-impregnated sheet 16 starts to evaporate as heating starts, whereby the sheet expands. At this time, since the first mold 21 and the second mold 22 are clamped with the sheet sandwiched therebetween, the expansion of the sheet is limited and the drying thus progresses with its size (thickness) and shape limited. Therefore, it finally becomes a dried sheet 19 having a predetermined shape and size. In addition, when a binder such as PVA is added to the slurry, it is possible to make shape retention properties of the molded hollow sheet excellent by curing the binder in the drying process, thereby facilitating handling or the like in subsequent processes.

Here, also in the drying process E, the heating and drying may be performed with the first spacers 23A and 23B having a thin thickness T1 used in the pressing process D retained. However, in the drying process E, if the heating and drying is performed with the first spacers 23A and 23B having a thin thickness T1 used in the pressing process D retained, the slurry is extruded in the drying process E, and accordingly, particles of the ceramic powder also flow out of the sheet, whereby a proportion of the portion which is not filled with the ceramic powder particles in the dried sheet becomes large. Therefore, there is a concern that porosity of the dried sheet will become large. Thus, in order to finish the sheet into a predetermined size and shape, and at the same time, to prevent the outflow of the slurry in the drying process to suppress the porosity of the dried sheet, it is preferable to use the second spacers 23A′ and 23B′ having a thicker thickness T2 in the drying process E as described above, instead of the first spacers 23A and 23B having a thin thickness T1 used in the pressing process D.

Returning back to FIG. 2, the sheet (dried sheet) 19 dried in the drying process E is then subjected to a firing process F. That is, the mold device 20 is disassembled, the dried sheet 19 is taken out, and the dried sheet 19 is then placed in a firing furnace such as an electric furnace (not shown), heated to a high temperature and fired. The firing temperature varies depending on types of the inorganic fiber and the ceramic powder, but is generally about 1100 to 1300 degrees Celsius. In particular, when alumina fibers are used as the inorganic fibers and alumina is used as the ceramic powder, it is preferably set to about 1200 degrees Celsius.

By firing in this way, the ceramic powder particles are not only fired and bonded to each other, but are also fired and bonded to the ceramic fibers, so that a member made of a ceramic matrix composite (CMC) having the shape and dimensions of the turbine vane 1 as shown in HG 1 is obtained. That is, the turbine vane 1 made of a composite material which has the ceramic derived from the ceramic powder as a matrix and is fiberized and reinforced with inorganic fibers is obtained.

As described above, by adjusting the thickness of the spacers interposed in the pressing process D and the thickness of the spacers interposed in the drying process E to appropriate thicknesses according to respective processes, the turbine vane (the turbine blade member) having a hollow portion, which is made of a ceramic matrix composite that finally has small porosity and high strength, and is excellent in shape accuracy and dimensional accuracy can be obtained.

In addition, in the present embodiment, since it is not necessary to weave fibers in a cylindrical shape and a general fiber sheet woven flat may be used, high strength ceramic fibers can also be used without causing a problem in the case of weaving fibers into a cylindrical shape, for example, a problem in which weaving high-strength ceramic fibers into a cylindrical shape is difficult. In addition, equipment and processes for weaving fibers into a cylindrical shape also become unnecessary, so that equipment cost is reduced and productivity also improves.

Further, since large-sized and expensive equipment such as an autoclave is unnecessary, this also enables cost reduction.

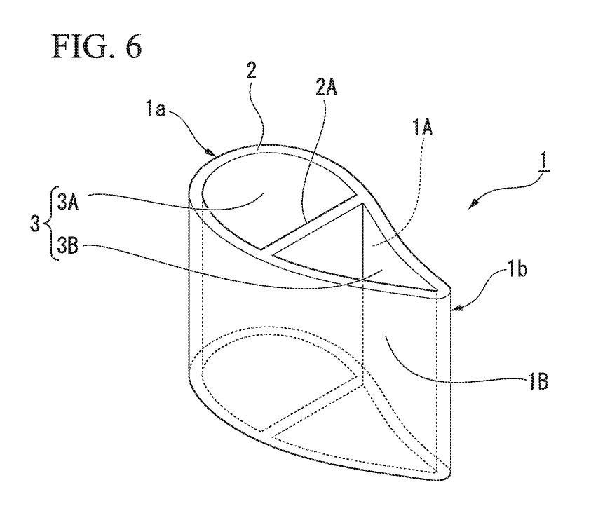

FIG. 6 shows a turbine vane 1 as an example of a turbine blade member manufactured according to a second embodiment of the present invention.

In the turbine vane 1 of the second embodiment, the hollow portion 3 is partitioned by a partition wall 2A and is configured to have two segment hollow portions 3A and 3B. Here, the partition wall 2A has a function of a rib for imparting strength. Similarly to the outer shell body 2, the partition wall 2A is made of a ceramic matrix composite in which inorganic fibers are combined and integrated using a ceramic as a matrix. The present embodiment is configured such that the segment hollow portion 3A on a leading edge 1a side and the segment hollow portion 3B on a trailing edge 1b side are partitioned by the partition wall 2A in the middle in a direction (a longitudinal direction) connecting the leading edge 1a and the trailing edge 1b of the turbine vane 1. Like the one shown in FIG. 1, an outward shape of the turbine vane 1 has a pressure side 1A forming a concave curved surface and a suction side 1B forming a convex curved surface or a flat surface.

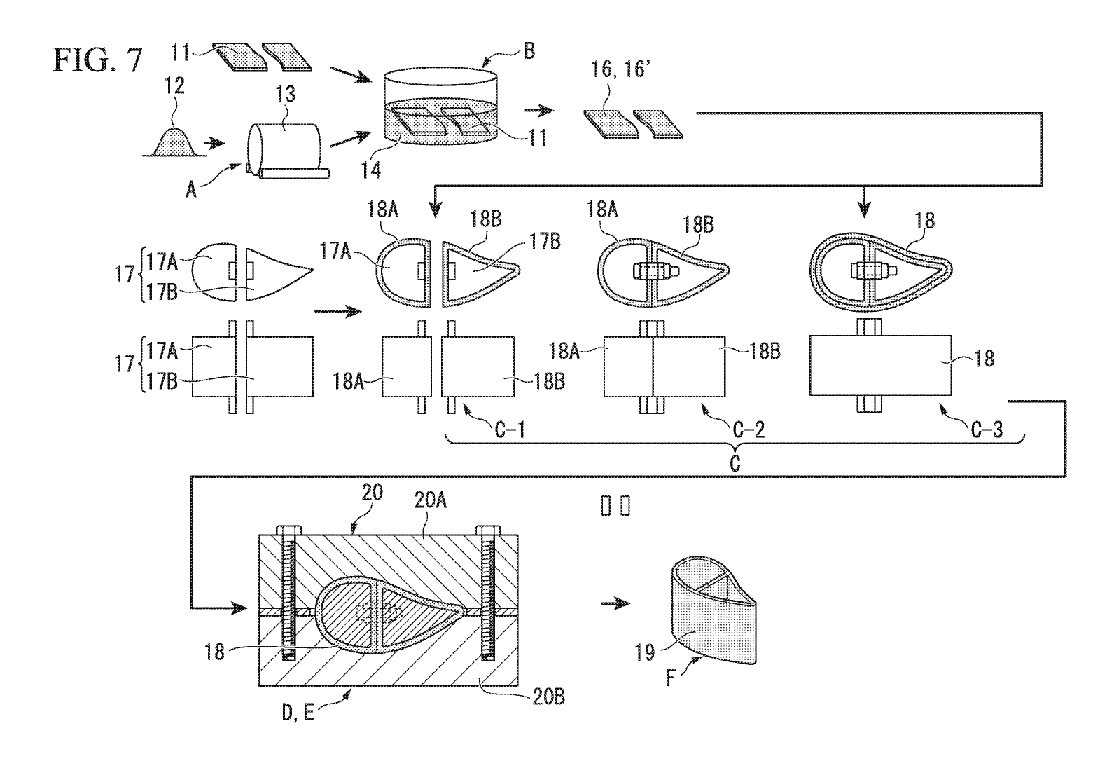

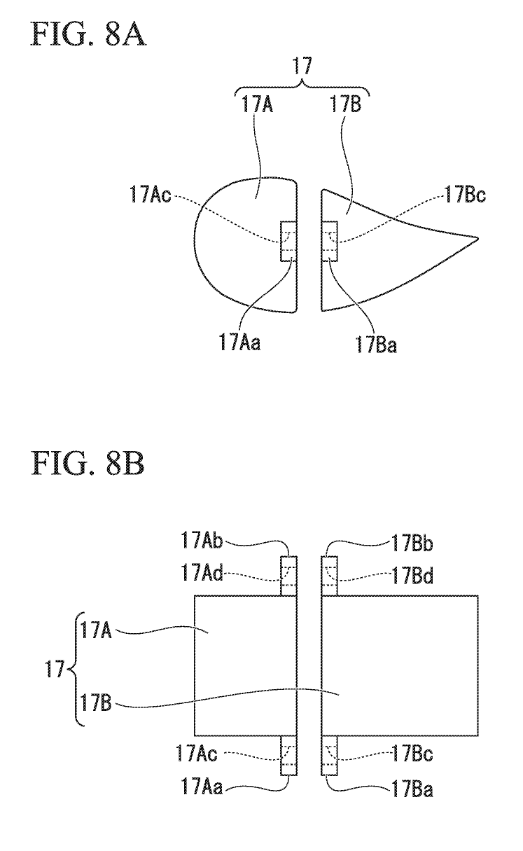

FIG. 7 shows an overall process configuration for manufacturing the turbine vane of the second embodiment. A main difference between the second embodiment and the first embodiment is that two core segment bodies 17A and 17B as shown in FIGS. 8A and 8B are used as the core 17, and the process C of winding the slurry-impregnated sheet around the core is also different from that of the first embodiment.

In FIG. 7, the process for producing slurry-impregnated sheets 16 and 16′ may be the same as the process of the first embodiment shown in FIG. 2.

On the other hand, as shown in an enlarged form in FIGS. 8A and 8B, two core segment bodies 17A and 17B are prepared as the core 17. The shape of an outer surface of one core segment body 17A corresponds to the shape of the inner surface of the segment hollow portion 3A on the leading edge 1a side of the turbine vane 1 of the product, and the shape of an outer surface of the other core segment body 17B corresponds to the shape of the inner surface of the segment hollow portion 3B on the trailing edge 1b side. In addition, connecting protrusions 17Aa and 17Ab; 17Ba and 17Bb which protrude outward at positions close to each other are formed on both sides in a width direction of the core segment bodies 17A and 17B. Through holes 17Ac and 17Ad; 17Bc and 17Bd are formed in the connecting protrusions 17Aa and 17Ab; 17Ba and 17Bb, respectively, in the longitudinal direction.

In the second embodiment, the sheet winding process C using the core segment bodies 17A and 17B described above includes the steps C-1 to C-3 as set forth below:

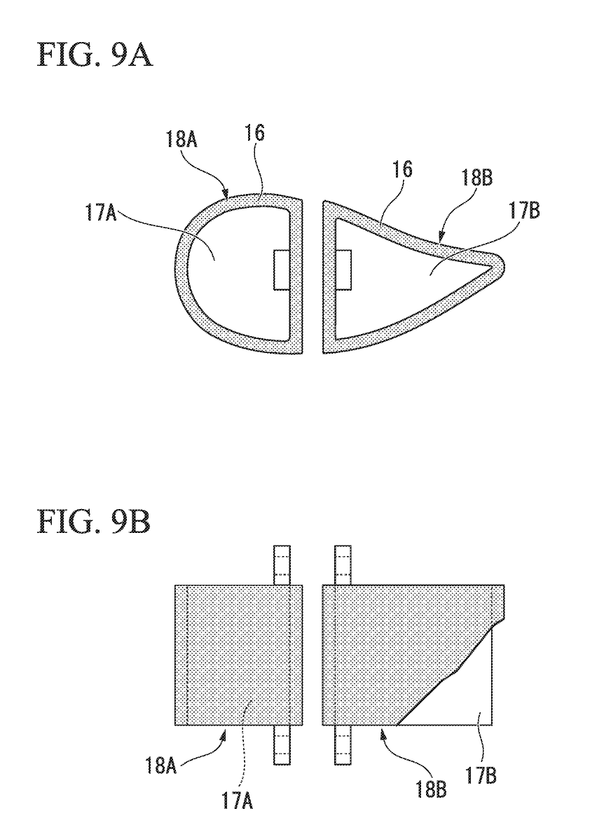

C-1: A step of winding the slurry-impregnated sheet 16 individually around each of the core segment bodies 17A and 17B to prepare sheet-wound core segment bodies 18A and 18B (see FIGS. 9A and 9B);

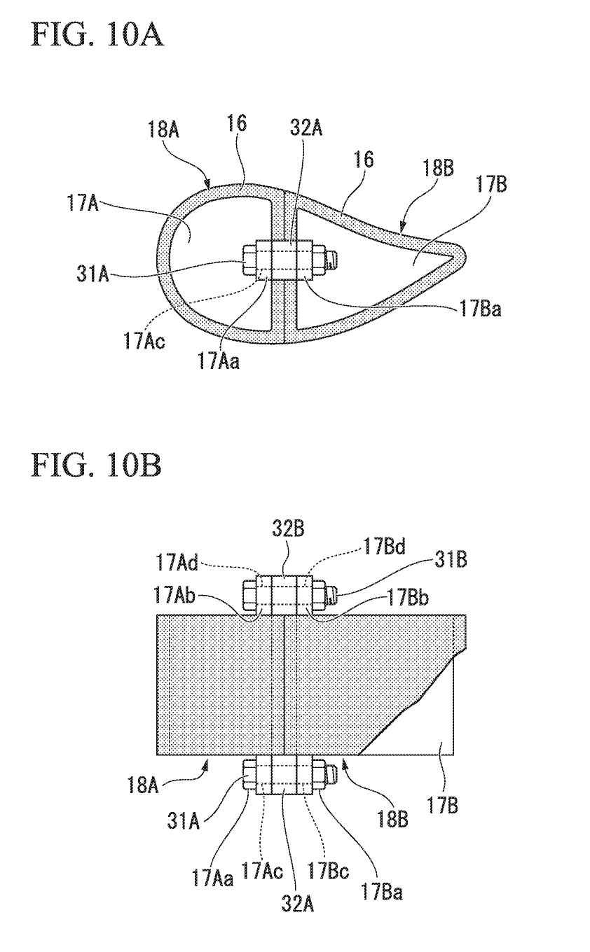

C-2: A step of combining a plurality of core segment bodies (the sheet-wound core segment bodies) 18A and 18B around which the slurry-impregnated sheet 16 is wound (see FIGS. 10A and 10B); and

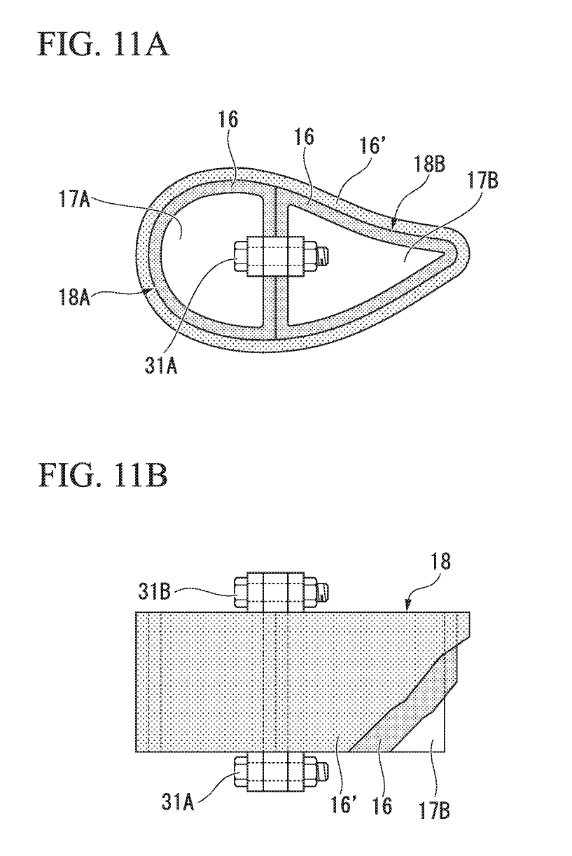

C-3: A step of winding another slurry-impregnated sheet 16′ again around the whole outer circumference of the combined sheet-wound core segment bodies 18A and 18B (see FIGS. 11A and 11B).

That is, first, in the step C-1, as shown in FIGS. 9A and 9B, the slurry-impregnated sheet 16 is wound around the outer circumference of each of the core segment bodies 17A and 17B to form the sheet-wound core segment bodies 18A and 18B.

Subsequently, in the step C-2, as shown in FIGS. 10A and 10B, the sheet-wound core segment bodies 18A and 18B abut each other and bolts 31A and 31B are inserted as second fasteners into the through holes 17Ac and 17Ad of the connecting protrusions 17Aa and 17Ab of one core segment body 17A and the through holes 17Bc and 17Bd of the connecting protrusions 17Ba and 17Bb of the other core segment body 17B and tightened, and then the slurry-impregnated sheet 16 is pressed and compressed between abutting portions of the sheet-wound core segment bodies 18A and 18B. At this time, spacers 32A and 32B are interposed between the connecting protrusions 17Aa and 17Ab of the one core segment body 17A and the other connecting protrusions 17Ba and 17Bb at positions which do not interfere with the bolts 31A and 31B. These spacers 32A and 32B are provided to prevent the slurry-impregnated sheet 16 from being excessively compressed between the abutting portions of the sheet-wound core segment bodies 18A and 18B.

In this way, by fastening the bolts 31A and 31B, the sheet-wound core segment bodies 18A and 18B are coupled and integrated, and the slurry-impregnated sheet 16 between the abutting portions of the sheet-wound core segment bodies 18A and 18B is compressed (pressed).

Further, in the step C-3, as shown in FIGS. 11A and 11B, the slurry-impregnated sheet 16′ is additionally wound around the whole outer circumference of the combined sheet-wound core segment bodies 18A and 18B. In this way, it is possible to eliminate unevenness and dents at the abutting portions of the sheet-wound core segment bodies 18A and 18B, thereby making the outer circumferential surfaces of the sheet-wound core segment bodies 18A and 18B smooth. As a result, the sheet-wound core 18 having the two core segment bodies 17A and 17B therein is produced.

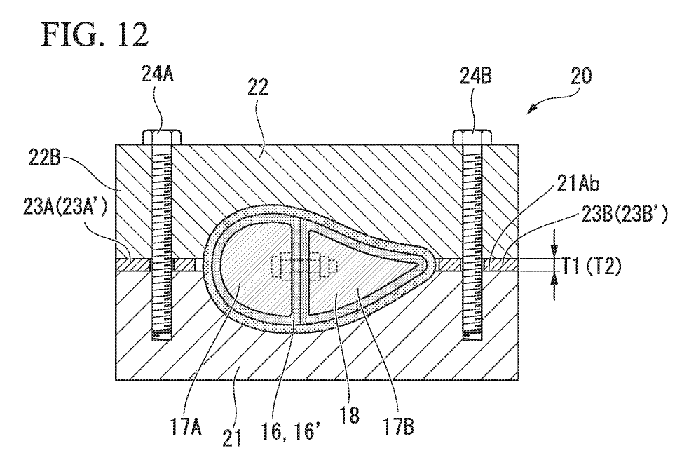

The sheet-wound core 18 produced through the sheet winding process C including the steps C-1 to C-3 described above is subjected to the pressing process D. In the pressing process D, a mold device 20 similar to that of the pressing process D according to the first embodiment may be used. FIG. 12 shows a state in which the sheet-wound core 18 is pressed in the pressing process D in the second embodiment.

As shown in FIG. 12, the slurry-impregnated sheet (the slurry-impregnated sheet 16 wound around each of the core segment bodies 17A and 17B, and the slurry-impregnated sheet 16′ wound around the circumference of the whole sheet-wound core segment bodies 18A and 18B) is placed into the mold device 20 including the first mold 21 and the second mold 22, and are pressed by clamping the first mold 21 and the second mold 22 together using fasteners (bolts) 24A and 24B while the spacers 23A and 23B are interposed between the molds.

Thereafter, it is subjected to the drying process E, but the drying process E may be the same as in the case of the first embodiment. That is, the whole mold device 20 may be placed in a drying device (not shown), heated and dried in a state in which the sheet which has been pressed in the mold device 20 in the pressing process D is retained (a state in which the first spacers 23A and 23B used in the drying process are interposed between the molds). However, in order to further improve shape accuracy and dimensional accuracy of the final product, it is preferable to change the spacers for the drying process E to those having a thickness different from that of the spacers used in the pressing process D as in the first embodiment, particularly, to change the spacers 23A and 23B used in the pressing process D to the spacers 23A′ and 23B′ having a larger thickness in the drying process E.

After drying, the mold device 20 is disassembled, and the dried sheet is taken out and subjected to a firing process F.

As a result, the turbine vane 1 in which the hollow portion 3 as shown in FIG. 6 is partitioned by the partition wall (rib) 2A to obtain the two segment hollow portions 3A and 3B can be made of the ceramic matrix composite.

Also, in the second embodiment described above, the hollow portion 3 is partitioned by one partition wall (rib) 2A to manufacture the turbine vane 1 having the two segment hollow portions 3A and 3B, and the core segment bodies 17A and 17B divided into two are used as the core 17. However, the number of dividing the hollow portion may be three or more, and in that case, three or more core segment bodies may also be used as the core.

In order to demonstrate effects of controlling the thicknesses of the spacers interposed between the first mold and the second mold in the pressing process and the drying process, the following experiments have been conducted.

### Experimental Example 1 and Experimental Example 2

As an inorganic fiber sheet, a woven cloth (fabric) sheet having an average thickness of 0.5 mm obtained by weaving alumina fibers into a flat shape was prepared. Also, alumina powder having an average particle size of 1 μm was used for the ceramic powder and slurried with water used as a dispersion medium. In addition, PVA was added as a binder to the slurry. The concentration of the slurry (the alumina concentration with respect to the total mass of the slurry) is 65% by mass, the PVA concentration is 1.5% by mass, and the porosity of the sheet is about 70%.

After the sheet was impregnated with the slurry, the slurry-impregnated sheet was pressed using a mold device. However, at that time, the mold device was not for molding a shape of a turbine vane as shown in FIGS. 2 and 3, and a combination of a lower mold (a first mold) and an upper mold (a second mold) having a simple flat shape were used. The configuration in which the first spacers are inserted and pressing is performed by bolt fastening was the same as that of the first embodiment.

As shown in Table 1, the thickness of the first spacers was set to 1.8 mm in Experimental example 1, and the thickness of the first spacers was set to 1.5 mm in Experimental example 2. In both of Experimental examples 1 and 2, after the slurry-impregnated sheet was pressed by bolt fastening, it was then heated to 100 degrees Celsius for 120 minutes without changing the spacers, and dried. Thereafter, the slurry-impregnated sheet was removed from the mold device, heated at 1,200 degrees Celsius for 4 hours, and fired.

A thickness (a product thickness) and porosity of the fired sheet were examined, and the results shown in Table 1 have been obtained.

### Experimental Examples 3 to 8

The same procedure as in Experimental examples 1 and 2 was carried out until the slurry was impregnated into the sheet and a slurry-impregnated sheet was obtained. Subsequently, pressing was performed by bolt fastening using the same mold device as in Experimental examples 1 and 2. However, in the pressing process, the thickness of the first spacers was set into five levels from 0.4 mm to 1.5 mm as shown in Table 2.

After completion of the pressing process, a drying process was implemented by changing the first spacers to the second spacers having a different thickness. The thickness of the second spacers in the drying process was uniformly set to 1.8 mm as shown in Table 2. Drying conditions are the same as in Experimental examples 1 and 2. Further, firing was carried out in the same manner as in Experimental examples 1 and 2.

For the sheet after firing, the thickness (the product thickness) and the porosity was examined, and the results shown in Table 2 has been obtained.

TABLE 1

Number of
Experimental
example

| | 1 | 2 |
|---|---|---|
| Thickness of First Spacers (mm) | 1.8 | 1.5 |
| Thickness of Sheet Product (mm) | 2.14 | 2.23 |
| Porosity (%) | 31.4 | 33.2 |

TABLE 2

| | Number of Experimental example | | | | | |
|---|---|---|---|---|---|---|
| | 3 | 4 | 5 | 6 | 7 | 8 |
| Thickness of First Spacers | 1.5 | 1.2 | 1.0 | 0.8 | 0.6 | 0.4 |
| (mm) | | | | | | |
| Thickness of Second Spacers | 1.8 | 1.8 | 1.8 | 1.8 | 1.8 | 1.8 |
| (mm) | | | | | | |
| Thickness of Sheet Product | 1.90 | 1.85 | 1.81 | 1.79 | 1.77 | 1.75 |
| (mm) | | | | | | |
| Porosity (%) | 29.5 | 28.8 | 27.6 | 26.5 | 25.5 | 25.7 |

From the results shown in Table 1 and Table 2, it has been confirmed that by controlling the thickness of the spacers when pressure is applied to the slurry-impregnated sheet by fastening the bolts in the mold device, the thickness and the porosity of the product sheet (the ceramic matrix composite sheet) can be controlled.

Also, as shown in Experimental example 1 and Experimental example 2, in the case where the pressing process was carried out by clamping the molds with the thickness of the first spacers set to 1.8 mm or 1.5 mm and the sheet was then dried and fired without changing the thickness of the spacers, the product thickness became as comparatively thick as 2 mm or more, and the porosity was as relatively high as 30% or more.

On the other hand, as shown in Experimental examples 3 to 8, in the case where the pressing process was carried out by inserting thin first spacers of 0.4 to 1.5 mm and clamping the molds, and then the spacers were changed to thicker second spacers of 1.8 mm to perform the drying process, the product thickness after firing was around 1.8 mm, and the porosity was reduced to 30% or less. It is considered that if the porosity is reduced as described above, strength characteristics or the like are also improved. In this case, since the porosity becomes 27% or less by setting the thickness of the first spacers in the pressing process to 0.4 to 0.8 mm, the porosity is further reduced to be favorable for the strength characteristics or the like.

Also, the turbine blade member obtained by the manufacturing method of the present invention is most suitable for manufacturing, for example, a blade main body portion (a blade portion) of a turbine vane in a large industrial gas turbine.

As described above, the preferred embodiments and examples of the present invention have been described. However, it should be understood that these embodiments and examples are merely examples within the scope of the gist of the present invention, and additions, omissions, substitutions, and other changes to the configuration are possible within the scope not deviating from the gist of the present invention. That is, the present invention is not limited by the above description, but is limited only by the scope of the appended claims, and it goes without saying that it can be appropriately changed within the scope thereof.

According to the manufacturing method of the turbine blade member, a turbine blade member made of a ceramic matrix composite having a hollow portion can be manufactured simply and inexpensively by a simple equipment configuration. In addition, it is possible to easily obtain a turbine blade member having an excellent dimensional accuracy and shape accuracy.

### EXPLANATION OF REFERENCES

A Slurry preparing process
B Impregnating process
C Sheet winding process
D Pressing process
E Drying process
F Firing process
Turbine vane (turbine blade member)
1A Hollow portion
11 Sheet made of inorganic fibers
12 Ceramic powder
16 Slurry-impregnated sheet
17 Core
17A, 17B Core segment body
20 Mold device
21 First mold (lower mold)
22 Second mold (upper mold)
23A, 23B First spacer
23A′, 23B′ Second spacer
24A, 24B Bolt (first fastener)
31A, 31B Bolt (second fastener)

What is claimed is:

1. A manufacturing method of a turbine blade member, comprising:
a slurry preparing process of preparing a slurry in which a ceramic powder is dispersed in a dispersion medium;
an impregnating process of impregnating the slurry into a sheet made of inorganic fibers to form a slurry-impregnated sheet;
a sheet winding process of winding the slurry-impregnated sheet around an outer circumferential surface of a core which has a shape of an outer surface corresponding to a shape of an inner surface of a hollow portion of the turbine blade member to form a sheet-wound core;
a pressing process of disposing the sheet-wound core between mold surfaces of a first mold having a mold surface corresponding to a suction side of the turbine blade member and a second mold having a mold surface corresponding to a pressure side of the turbine blade member, and clamping the first mold and the second mold with first fasteners to come close in a direction facing each other with the first spacer having a predetermined thickness interposed between the first mold and the second mold at a position where the slurry-impregnated sheet is not positioned, thereby applying pressure to the slurry-impregnated sheet;
a drying process of heating and drying the slurry-impregnated sheet after completion of the pressing process; and
a firing process of firing the sheet after drying.

2. The manufacturing method of the turbine blade member according to claim 1, wherein the entire core is integrally formed.

3. The manufacturing method of the turbine blade member according to claim 1, wherein the core includes a plurality of core segment bodies, and in the sheet winding process, the slurry-impregnated sheet is wound around each of the core segment bodies, and then the plurality of core segment bodies are combined to form the sheet-wound core.

4. The manufacturing method of the turbine blade member according to claim 3, wherein, in the sheet winding process, the slurry-impregnated sheet is wound around each of the core segment bodies and the plurality of core segment bodies are combined, and then another slurry-impregnated sheet is wound again around an outer surface of the combined core segment bodies to form the sheet-wound core.

5. The manufacturing method of the turbine blade member according to claim 3, wherein, when the plurality of core segment bodies are combined in the sheet winding process, the plurality of core segment bodies are combined with second fasteners.

6. The manufacturing method of the turbine blade member according to claim 1, wherein, in the drying process, in a state in which a second spacer having a thickness different from that of the first spacer is interposed, instead of the first spacer, between the first mold and the second mold at a position where the slurry-impregnated sheet is not positioned, the first mold and the second mold are clamped with the first fasteners to come close in the direction facing each other, and in this state, the slurry-impregnated sheet is heated and dried.

7. The manufacturing method of the turbine blade member according to claim 6, wherein, in the drying process, a spacer whose thickness is larger than a thickness of the first spacer is used as the second spacer.

8. The manufacturing method of the turbine blade member according to claim 1, wherein each of the fasteners is a bolt.
